(19) United States
(12) Patent Application Publication
(10) Pub. No.: US 2011/0217977 A1
(43) Pub. Date: Sep. 8, 2011

(54) SYSTEMS AND METHODS FOR INCREMENTAL UPDATE OF A PREFERRED ROAMING LIST

(75) Inventors: Zhimin Du, Beijing (CN); Yan Li, Beijing (CN)

(73) Assignee: QUALCOMM Incorporated, San Diego, CA (US)

(21) Appl. No.: 13/037,554

(22) Filed: Mar. 1, 2011

(30) Foreign Application Priority Data
Mar. 2, 2010 (CN) 201010126141.X

(51) Int. Cl. H04W 4/00

(52) U.S. Cl. 455/432.1

(57) ABSTRACT

A system and method of incrementally updating a preferred roaming list (PRL) are disclosed. The systems and methods include modifying a removable user identity module (RUIM) card on the mobile device to accept data structures that include incremental update information for a PRL. The systems and methods also include modifying a removable user identity module (RUIM) card on the mobile device to execute operators that allow for a PRL to be incrementally updated.

### CLAIM OF PRIORITY

The present application for patent claims priority to Chinese Patent Application No. 201010126141.X, filed Mar. 2, 2010, which is hereby expressly incorporated by reference herein.

### BACKGROUND

1. Field

The present application relates generally to wireless communication, and more specifically to systems and methods for incrementally updating a preferred roaming list (PRL).

2. Background

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

Within wireless communication systems, mobile devices typically are associated with a particular wireless carrier (a home carrier). The home carrier may provide access nodes in a home area to allow the mobile devices to communicate within a communication network. In some instances, however, the mobile device may move outside the home area where the home carrier provides wireless access. In such areas, another carrier may provide wireless access through access nodes controlled by the other carrier. Accordingly, the mobile device may “roam” or attempt to connect to the access nodes controlled by the other carrier. In order to aid the mobile device in finding such access points controlled by the other carrier, the wireless device may access a preferred roaming list (PRL). The PRL may be a database that resides on a removable user identity module (RUIM) card on the mobile device. The PRL indicates which bands, sub bands and service provider identifiers will be scanned and in what priority order to find access nodes controlled by carriers other than the home carrier.

The PRL may be updated regularly such as depending on the area the mobile device is in, and changes to the wireless networks of different carriers. Therefore, it is desirable to have systems and methods that allow for efficient updating of the PRL on a mobile device.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include allowing for incremental update of a preferred roaming list (PRL) on a mobile device.

One embodiment of the disclosure provides a communication apparatus configured to update a preferred roaming list in a mobile device. The apparatus comprises a processor. The processor is configured to identify a data location in the preferred roaming list. The processor is further configured to identify a type of operation to perform with respect to the identified data location. The processor is further configured to generate data indicative of an updated portion of the preferred roaming list. The apparatus further comprises a transmitter configured to transmit a message indicative of the data location, the type of operation, and the data to a mobile device.

Another embodiment of the disclosure provides a communication apparatus configured to update a preferred roaming list in a mobile device. The apparatus comprises a receiver configured to receive a data structure. The data structure comprises an indicator of a data location to modify the preferred roaming list. The data structure further comprises an indicator of a type of operation to perform. The data structure further comprises an updated portion of the preferred roaming list. The apparatus further comprises a processor configured to modify the preferred roaming list based on the data structure.

Yet another embodiment of the disclosure provides a communication apparatus configured to update a preferred roaming list in a mobile device. The apparatus comprises a processor configured to generate a message comprising one or more indicators of one or more operators executable by a removable user identity module (RUIM) card, wherein the one or more operators are configured to modify a preferred roaming list. The apparatus further comprises a transmitter configured to transmit the message to a mobile device.

Another embodiment of the disclosure provides a communication apparatus configured to update a preferred roaming list in a mobile device. The apparatus comprises a receiver configured to receive a message comprising one or more indicators of one or more operators executable by a removable user identity module (RUIM) card, wherein the one or more operators are configured to modify a preferred roaming list. The apparatus further comprises a processor configured to modify the preferred roaming list based on the one or more operators.

Yet another embodiment of the disclosure provides a method for updating a preferred roaming list in a mobile device. The method comprises identifying a data location in the preferred roaming list. The method further comprises identifying a type of operation to perform with respect to the identified data location. The method further comprises generating data indicative of an updated portion of the preferred roaming list. The method further comprises transmitting a message indicative of the data location, the type of operation, and the data to a mobile device.

Another embodiment of the disclosure provides a method for updating a preferred roaming list in a mobile device. The method comprises receiving a data structure. The data structure comprises an indicator of a data location to modify the preferred roaming list. The data structure further comprises an indicator of a type of operation to perform. The data structure further comprises an updated portion of the preferred roaming list. The method further comprises modifying the preferred roaming list based on the data structure.

Yet another embodiment of the disclosure provides a method for updating a preferred roaming list in a mobile device. The method comprises generating a message comprising one or more indicators of one or more operators executable by a removable user identity module (RUIM) card, wherein the one or more operators are configured to modify a preferred roaming list. The method further comprises transmitting the message to a mobile device.

Another embodiment of the disclosure provides a method for updating a preferred roaming list in a mobile device. The method comprises receiving a message comprising one or more indicators of one or more operators executable by a removable user identity module (RUIM) card, wherein the one or more operators are configured to modify a preferred roaming list. The method further comprises modifying the preferred roaming list based on the one or more operators.

Yet another embodiment of the disclosure provides a communication apparatus configured to update a preferred roaming list in a mobile device. The apparatus comprises means for identifying a data location in the preferred roaming list. The apparatus further comprises means for identifying a type of operation to perform with respect to the identified data location. The apparatus further comprises means for generating data indicative of an updated portion of the preferred roaming list. The apparatus further comprises means for transmitting a message indicative of the data location, the type of operation, and the data to a mobile device.

Another embodiment of the disclosure provides a communication apparatus configured to update a preferred roaming list in a mobile device. The apparatus comprises means for receiving a data structure. The data structure comprises an indicator of a data location to modify the preferred roaming list. The data structure further comprises an indicator of a type of operation to perform. The data structure further comprises an updated portion of the preferred roaming list. The apparatus further comprises means for modifying the preferred roaming list based on the data structure.

Yet another embodiment of the disclosure provides a communication apparatus configured to update a preferred roaming list in a mobile device. The apparatus comprises means for generating a message comprising one or more indicators of one or more operators executable by a removable user identity module (RUIM) card, wherein the one or more operators are configured to modify a preferred roaming list. The apparatus further comprises means for transmitting the message to a mobile device.

Another embodiment of the disclosure provides a communication apparatus configured to update a preferred roaming list in a mobile device. The apparatus comprises means for receiving a message comprising one or more indicators of one or more operators executable by a removable user identity module (RUIM) card, wherein the one or more operators are configured to modify a preferred roaming list. The apparatus further comprises means for modifying the preferred roaming list based on the one or more operators.

Yet another embodiment of the disclosure provides a non-transitory computer program product, comprising a computer-readable medium. The computer-readable medium comprises code for causing a computer to identify a data location in the preferred roaming list. The computer-readable medium further comprises code for causing a computer to identify a type of operation to perform with respect to the identified data location. The computer-readable medium further comprises code for causing a computer to generate data indicative of an updated portion of the preferred roaming list. The computer-readable medium further comprises code for causing a computer to transmit a message indicative of the data location, the type of operation, and the data to a mobile device.

Another embodiment of the disclosure provides a non-transitory computer program product, comprising a computer-readable medium. The computer-readable medium comprises code for causing a computer to receive a data structure. The data structure comprises an indicator of a data location to modify the preferred roaming list. The data structure further comprises an indicator of a type of operation to perform. The data structure further comprises an updated portion of the preferred roaming list. The computer-readable medium further comprises code for causing a computer to modify the preferred roaming list based on the data structure.

Yet another embodiment of the disclosure provides a non-transitory computer program product, comprising a computer-readable medium. The computer-readable medium comprises code for causing a computer to generate a message comprising one or more indicators of one or more operators executable by a removable user identity module (RUIM) card, wherein the one or more operators are configured to modify a preferred roaming list. The computer-readable medium further comprises code for causing a computer to transmit the message to a mobile device.

Another embodiment of the disclosure provides a non-transitory computer program product, comprising a computer-readable medium. The computer-readable medium comprises code for causing a computer to receive a message comprising one or more indicators of one or more operators executable by a removable user identity module (RUIM) card, wherein the one or more operators are configured to modify a preferred roaming list. The computer-readable medium further comprises code for causing a computer to modify the preferred roaming list based on the one or more operators.

### BRIEF DESCRIPTION OF THE DRAWINGS

FIG. 1 illustrates an exemplary wireless communication network.

FIG. 2 illustrates functional block diagrams of an exemplary node and an exemplary access terminal shown in FIG. 1.

FIG. 3 illustrates a table that represents a data structure that may be transmitted by the node to the access terminal to update the preferred roaming list stored at the access terminal shown in FIG. 1.

FIG. 4 illustrates a table that represents a portion of the data structure represented by the table of FIG. 3.

FIG. 5 illustrates a table that represents a portion of the data structure represented by the table of FIG. 3.

FIG. 6 illustrates a table that represents a portion of the data structure represented by the table of FIG. 3.

FIG. 7 illustrates a table that represents a data structure that may be transmitted by the node to the access terminal to update an extended preferred roaming list stored at the access terminal shown in FIG. 1.

FIG. 8 illustrates a table that represents a portion of the data structure represented by the table of FIG. 7.

FIG. 9 illustrates a table that represents a portion of the data structure represented by the table of FIG. 7.

FIG. 10 illustrates a table that represents the data sent in a single short message service message for performing incremental concatenated preferred roaming list update.

FIG. 11 illustrates a table that represents another data structure that may be transmitted by the node to the access terminal to update the preferred roaming list stored at the access terminal shown in FIG. 1.

FIG. 12 illustrates a table that represents a portion of the data structure represented by the table of FIG. 11.

FIG. 13 illustrates a table that represents another data structure that may be transmitted by the node to the access terminal to update an extended preferred roaming list stored at the access terminal shown in FIG. 1.

FIG. 14 illustrates a table that represents yet another data structure that may be transmitted by the node to the access terminal to update a preferred roaming list stored at the access terminal shown in FIG. 1.

FIG. 15 illustrates a table that represents a portion of the data structure represented by the table of FIG. 14.

FIG. 16 is a flowchart of an exemplary process for updating the preferred roaming list of the access terminal shown in FIG. 1.

FIG. 17 illustrates a table that represents a store operator executable by a removable user identity module card.

FIG. 18 illustrates a table that represents a memory move operator executable by the removable user identity module card.

FIG. 19 illustrates a table that represents a bit shift operator executable by the removable user identity module card.

FIG. 20 illustrates a table that represents a commit operator executable by the removable user identity module card.

FIG. 21 illustrates a table that represents a long move operator executable by the removable user identity module card.

FIG. 22 is a flowchart of an exemplary process for updating the preferred roaming list of the access terminal shown in FIG. 1.

FIG. 23 illustrates a functional block diagram of another exemplary access terminal shown in FIG. 1.

FIG. 24 illustrates a functional block diagram of a home carrier server.

FIG. 25 illustrates a functional block diagram of another home carrier server.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

In some aspects the teachings herein may be employed in a network that includes macro scale coverage (e.g., a large area cellular network such as a 3rd Generation (3G) networks, typically referred to as a macro cell network) and smaller scale coverage (e.g., a residence-based or building-based network environment). As an access terminal (“AT”) moves through such a network, the access terminal may be served in certain locations by access nodes (“ANs”) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, and so on.

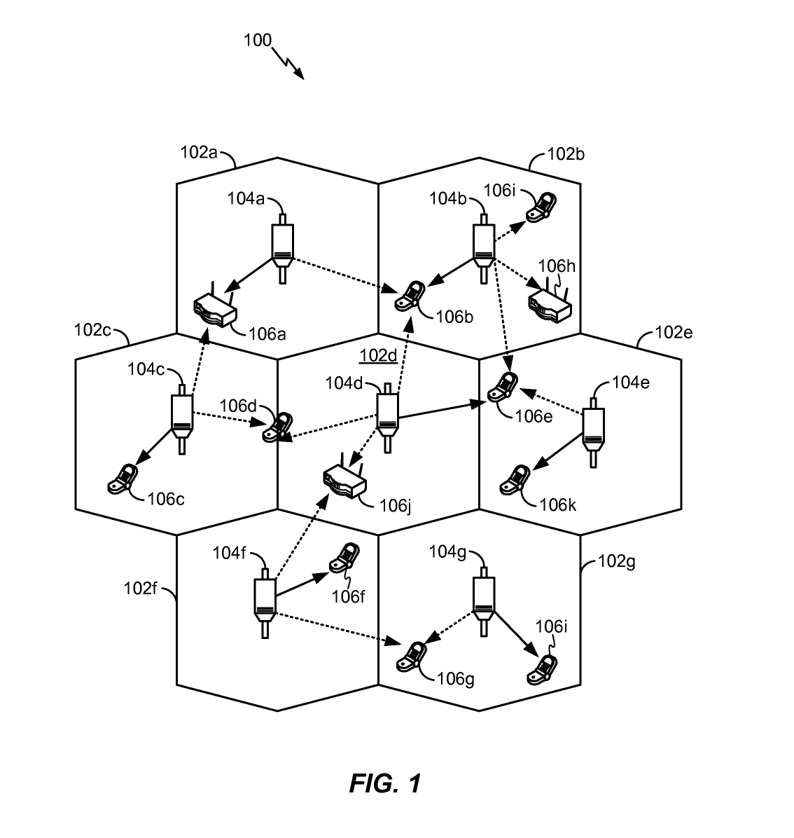

FIG. 1 illustrates an exemplary wireless communication network 100. The wireless communication network 100 is configured to support communication between a number of users. The wireless communication network 100 may be divided into one or more cells 102, such as, for example, cells 102a-102g. Communication coverage in cells 102a-102g may be provided by one or more nodes 104 (e.g., base stations, access points, etc.), such as, for example, nodes 104a-104g. Each node 104 may provide communication coverage to a corresponding cell 102. The nodes 104 may interact with a plurality of access terminals (ATs), such as, for example, ATs 106a-1061.

Each AT 106 may communicate with one or more nodes 104 on a forward link (FL) and/or a reverse link (RL) at a given moment. A FL is a communication link from a node to an AT. A RL is a communication link from an AT to a node. The FL may also be referred to as the downlink. Further, the RL may also be referred to as the uplink. The nodes 104 may be interconnected, for example, by appropriate wired or wireless interfaces and may be able to communicate with each other. Accordingly, each AT 106 may communicate with another AT 106 through one or more nodes 104. For example, the AT 106j may communicate with the AT 106h as follows. The AT 106j may communicate with the node 104d. The node 104d may then communicate with the node 104b. The node 104b may then communicate with the AT 106h. Accordingly, a communication is established between the AT 106j and the AT 106h.

The wireless communication network 100 may provide service over a large geographic region. For example, the cells 102a-102g may cover only a few blocks within a neighborhood or several square miles in a rural environment. In one embodiment, each cell may be further divided into one or more sectors (not shown).

As described above, a node 104 may provide an access terminal (AT) 106 access within its coverage area to a communications network, such as, for example the internet or a cellular network. Each node 104 may be controlled by a given wireless carrier. An AT 106 may be associated with a particular wireless carrier, such as a home carrier, that provides wireless coverage to the AT 106 through nodes 104 controlled by the home carrier. For example, a user of the AT 106 may sign an agreement with the home carrier and in turn the home carrier may allow the AT 106 to access its wireless network via nodes 104 the home carrier controls. In some instances, the AT 106 may enter an area where the home carrier does not provide coverage as the home carrier has no nodes 104 in the area to provide service to the AT 106. There may, however, be nodes 104 controlled by other carriers. The home carrier have agreements with the other carriers to allow AT 106 to “roam” or access nodes 104 controlled by the other carriers. The AT 106 may utilize a PRL to locate and connect to such access nodes 104 controlled by the other carriers. As used herein, PRL may refer to an extended PRL (ePRL), a PRL, and/or a concatenated PRL (CPRL). The home carrier may further periodically send updates via a node 104 to the AT 106 updating the PRL as discussed below.

An AT 106 may be a wireless communication device (e.g., a mobile phone, router, personal computer, server, etc.) used by a user to send and receive voice or data over a communications network. An access terminal (AT) may also be referred to herein as a user equipment (UE), as a mobile station (MS), or as a terminal device. As shown, ATs 106a, 106h, and 106j comprise routers. ATs 106b-106g, 106i, 106k, and 106l comprise mobile phones. However, each of ATs 106a-1061 may comprise any suitable communication device.

A wireless multiple-access communication system may simultaneously support communication for multiple wireless access terminals. As mentioned above, each access terminal may communicate with one or more nodes via transmissions on the forward and reverse links. The forward link (or downlink) refers to the communication link from the node to the access terminal, and the reverse link (or uplink) refers to the communication link from the access terminal to the node. This communication link may be established via a single-in-single-out system, a multiple-in-multiple-out (“MIMO”) system, or some other type of system.

A MIMO system employs multiple (NT) transmit antennas and multiple (NR) receive antennas for data transmission. A MIMO channel formed by the NT transmit and NR receive antennas may comprise NS independent channels, which are also referred to as spatial channels, where NS≦min{NT, NR}. Each of the NS independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables a device (e.g., a node, an access terminal, etc.) to extract a transmit beam-forming gain on the forward link when multiple antennas are available at the device.

The teachings herein may be incorporated into a device (e.g., a node, an access terminal, etc.) employing various components for communicating with at least one other device.

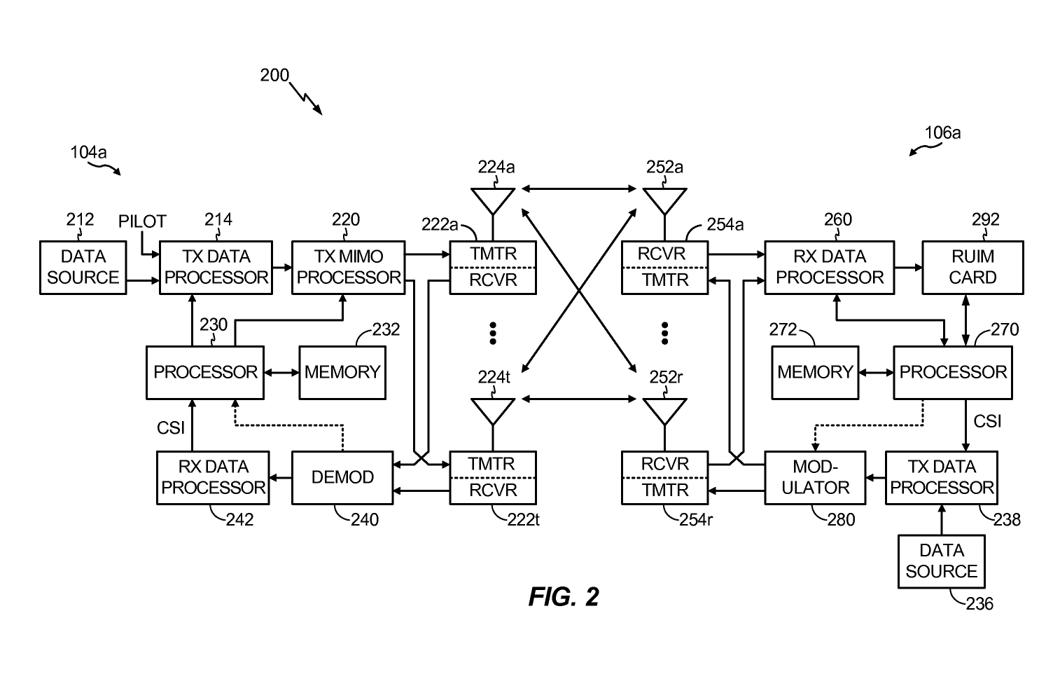

FIG. 2 illustrates functional block diagrams of an exemplary node 104a and an exemplary access terminal 106a shown in FIG. 1. In a MIMO system 200, the node 104a communicates with one or more ATs such as the AT 106a. At the node 104a, traffic data for a number of data streams is provided from a data source 212 to a transmit (“TX”) data processor 214.

In one embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 230. A data memory 232 may store program code, data, and other information used by the processor 230 or other components of the node 104a.

The modulation symbols for all data streams are then provided to a TX MIMO processor 220, which may further process the modulation symbols (e.g., for OFDM). The TX MIMO processor 220 then provides NT modulation symbol streams to NT transceivers (“XCVR”) 222A through 222T. In some aspects, the TX MIMO processor 220 applies beam-forming weights to the symbols of the data streams and to the antenna from which the symbol is being transmitted.

Each transceiver 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 222A through 222T are then transmitted from NT antennas 224A through 224T, respectively.

At the AT 106a, the transmitted modulated signals are received by NR antennas 252A through 252R and the received signal from each antenna 252 is provided to a respective transceiver (“XCVR”) 254A through 254R. Each transceiver 254 conditions (e.g., filters, amplifies, and downconverts) a respective received signal, digitizes the conditioned signal to provide samples, and further processes the samples to provide a corresponding “received” symbol stream.

A receive (“RX”) data processor 260 then receives and processes the NR received symbol streams from NR transceivers 254 based on a particular receiver processing technique to provide NT “detected” symbol streams. The RX data processor 260 then demodulates, deinterleaves, and decodes each detected symbol stream to recover the traffic data for the data stream. The processing performed by the RX data processor 260 is complementary to that performed by the TX MIMO processor 220 and the TX data processor 214 at the node 104a.

A processor 270 periodically determines which pre-coding matrix to use (discussed below). The processor 270 formulates a reverse link message comprising a matrix index portion and a rank value portion. A data memory 272 may store program code, data, and other information used by the processor 270 or other components of the AT 106a.

The AT 106a may further include a removable user identity Module (RUIM) card 273. The RUIM card 273 may be in data communication with the processor 270. The RUIM card 273, as is known in the art, act as a storage for particular information, and further may include a processor to execute commands that change or utilize the information stored on the RUIM card 273. For example, the RUIM card 273 stores a preferred roaming list (PRL) for the AT 106a. Further, the RUIM card 273 is configured to execute instructions to read/write/update/delete information stored on the RUIM card 273, such as the PRL data.

The reverse link message may comprise various types of information regarding the communication link and/or the received data stream. The reverse link message is then processed by a TX data processor 238. The TX data processor 238 also receives traffic data for a number of data streams from a data source 236. The modulator 280 modulates the data streams. Further, the transceivers 254A through 254R condition the data streams and transmit the data streams back to the node 104a.

At the node 104a, the modulated signals from the AT 106a are received by the antennas 224. Further, the transceivers 222 condition the modulated signals. A demodulator (“DEMOD”) 240 demodulates the modulated signals. A RX data processor 242 processes the demodulated signals and extracts the reverse link message (e.g., information) transmitted by the AT 106a. The processor 230 then determines which pre-coding matrix to use for determining the beam-forming weights. Further, the processor 230 processes the extracted message. It should be appreciated that for each node 104a and AT 106a the functionality of two or more of the described components may be provided by a single component.

It should be understood that FIG. 2 is just one example of an AT 106a and a node 104. The AT 106a and the node 104 may also each comprise any suitable communication device may further comprise a memory for storing data and/or instructions, a processor for executing instructions and performing the methods described herein, and a transceiver (or a receiver and a transmitter) for communicating data and/or some other communication interface.

As discussed above with respect to FIG. 2, the AT 106a stores a PRL. The PRL includes an acquisition table, which lists the frequencies and bands that the AT 106a may use to search for nodes 104 when roaming. The PRL further includes a system table, which includes the identification information of the preferred networks that the AT 106a should preferably connect to via nodes 104 controlled by the preferred networks' carriers. The system table also includes additional information.

The AT 106a may store the PRL, for example, on an RUIM card 273 and/or memory 272. The AT 106a may further update the PRL per messages received from a home carrier. Traditionally a PRL may be 1 kilobyte (KB) in size. Accordingly, in one embodiment, the home carrier may transmit to the AT 106a via the node 104a four short message service (SMS) messages to update the entire PRL stored at the AT 106a. The SMS messages may include the entire PRL, and accordingly the AT 106a may replace the previously stored PRL with the received PRL.

In other embodiments, the PRL may be larger than 1 KB. For example, the PRL may be 8 KB or even 16 KB or longer. Transmission of the entire PRL via SMS for such larger PRLs may be problematic. This is because, though the probability of receiving a single SMS message successfully is relatively high, the probability of receiving several SMS messages required for an update decreases exponentially with respect to the number of SMS messages needed. For example as required for a 1 KB PRL, the success rate of receiving 4 transmitted SMS messages is 90%-95%. However, for larger PRLs, additional SMS messages may be sent to transmit the entire PRL. For example as required for a 8 KB PRL, the success rate of receiving 32 transmitted SMS messages is 43%-66%. As required for a 16 KB PRL, the success rate of receiving 64 transmitted SMS messages is 18.5%-44%.

In many instances, the entire PRL does not change in each update, but rather only a portion of the PRL changes. Accordingly, redundant data is sent in each update requiring the entire PRL to be sent. By eliminating transmission of such redundant data and only transmitting the incrementally changed portions of the PRL, fewer SMS messages can be used to transmit the PRL, which leads to higher success rates.

Below are described several methods for incrementally updating a PRL that may be performed by the AT 106a. It should be noted that these methods also apply to updating an extended PRL (ePRL). In one embodiment, the methods are performed by modifying the RUIM card 273 of the AT 106a. In other embodiments, other components of the AT 106a may be modified as understood by one of skill in the art. Therefore, though the examples below are specifically described with respect to modifying an RUIM card 273, it should be noted that the methods also apply to modification of other components of the AT 106a. One advantage of modifying the RUIM card 273, however, is that the RUIM card 273 is typically a cheap user-replaceable component of the AT 106a. By replacing the RUIM card 273 the methods described below can be implemented in existing mobile devices without further modifying the existing mobile devices. This provides a cost effective solution for changing how PRLs are updated.

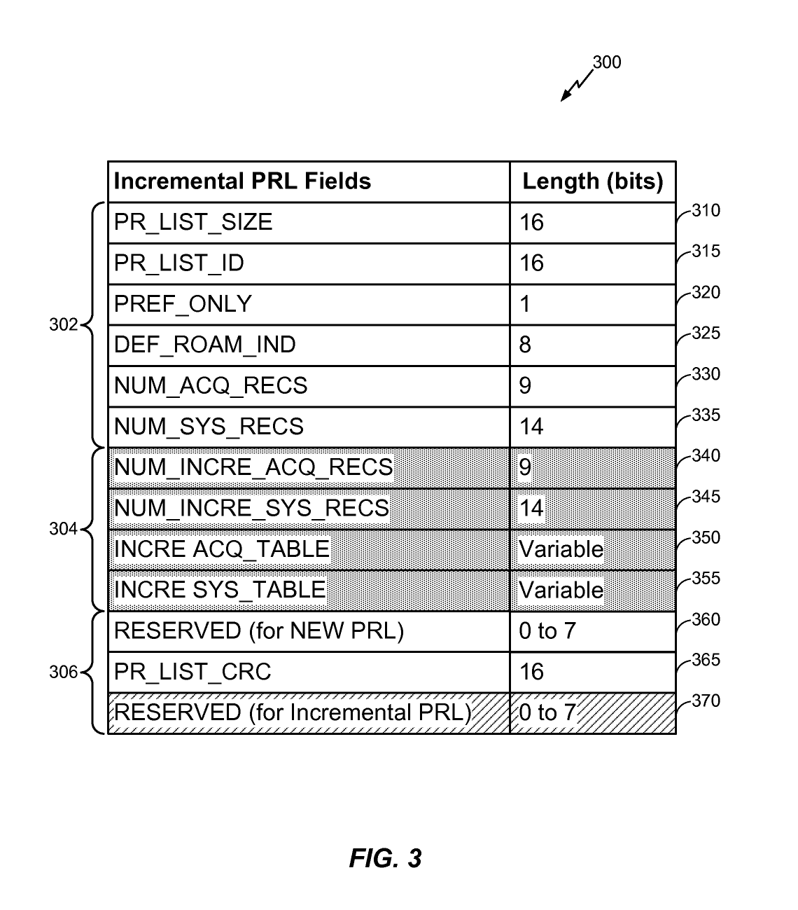

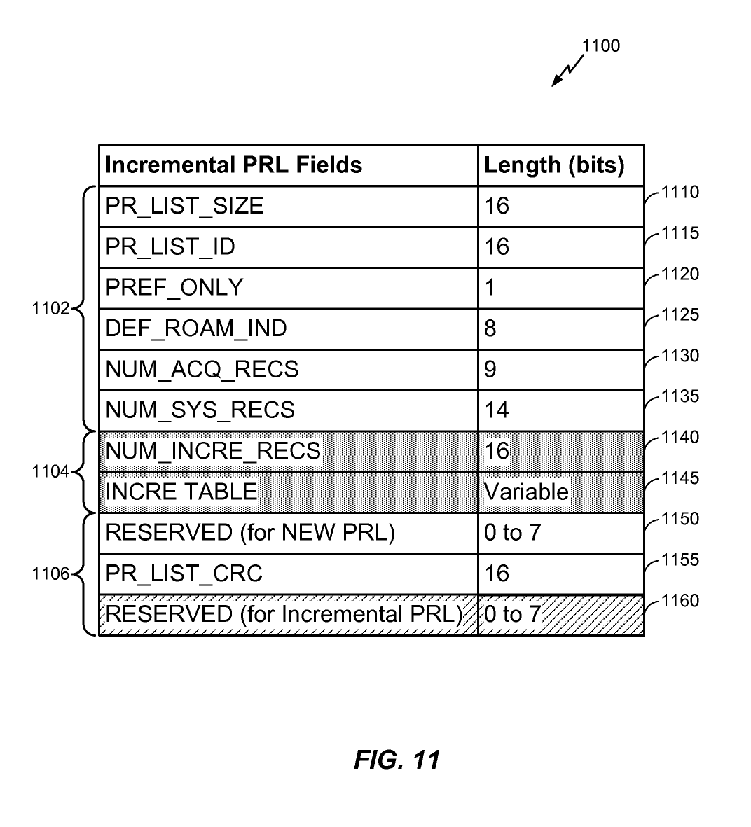

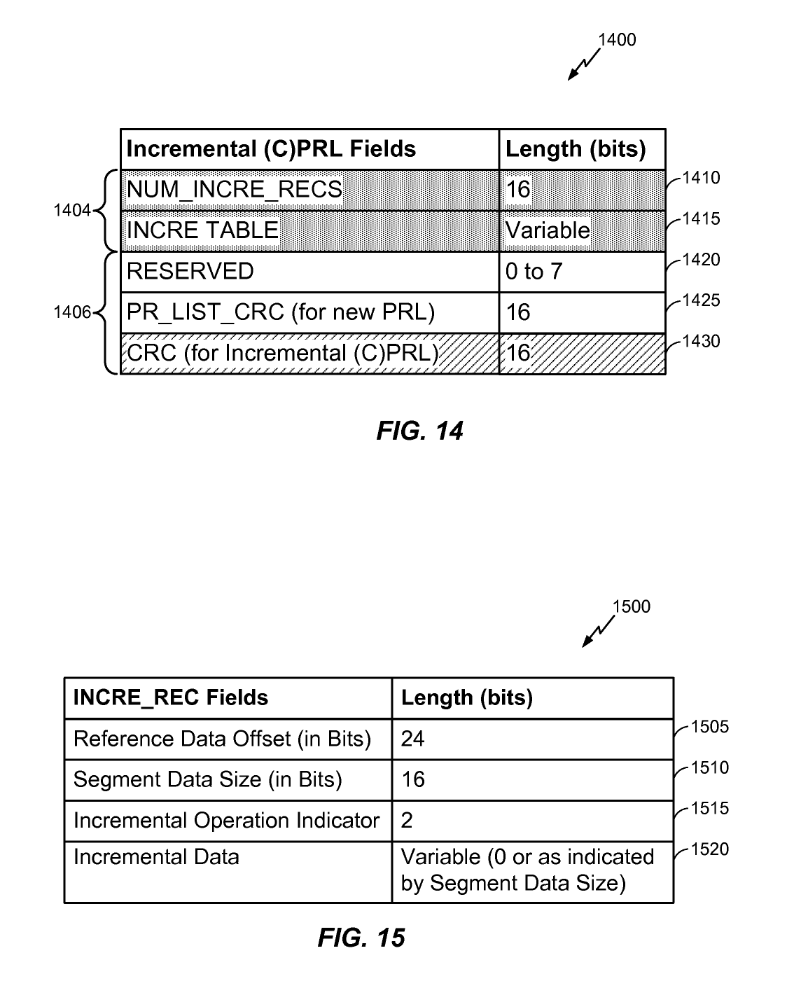

One method of incrementally updating a PRL includes sending modified PRL data structures to the AT 106a via the node 104. The RUIM card 273 is designed to recognize the modified data structure and change the PRL accordingly. The data structure indicates whether the RUIM card 273 should replace data in the PRL, add data to the PRL, or remove data from the PRL. In one embodiment, the modified structure further includes an identification of which records to update of an acquisition table and a system information table and the updated information itself. In another embodiment, the modified structure indicates a data offset that indicates in the number of bits where from the start of the PRL data to begin modifying the data, the size of the data update, and the update data itself. In some embodiments, the data structure includes a standard PRL header. These methods are described in further detail below with respect to FIGS. 3-15. One method is described with respect to FIGS. 3-10. Another method is described with respect to FIGS. 11-13. Yet another method is described with respect to FIGS. 14-15.

In yet another embodiment, the RUIM card 273 is modified to understand one or more operators such as add data, delete data, update data, a loop command, a bit shift command, a move command, etc. The home carrier then sends the operators and the data to be updated to the AT 106a via the node 104. The RUIM card 273 executes the operators. By executing the operators, the PRL is updated with the transmitted data according to the order of the operators and can be done so incrementally. These methods are described in further detail below.

FIG. 3 illustrates a table 300 that represents a data structure that may be transmitted by the node 104 to the AT 106a to update the PRL stored at the AT 106a. The AT 106a may use the data structure to update the PRL incrementally by changing data stored on the RUIM card 273 per the instructions contained in the data structure. The data structure may be a variable number of bits. The table 300 indicates what the bits in the data structure represent. For example, the first 64 bits of the data structure include header information for the data structure that is represented by a first portion 302. The header information includes different fields as shown in first portion 302. For example, the first field of the header information defines the size of the PRL and is referred to by the field name PR_LIST_SIZE field 310. Further, as shown in table 300, the PR_LIST_SIZE field 310 is made up of 16 bits. The remaining fields of the header information, as shown in the first portion 302, define: an identifier of the PRL to be updated (“PRL_LIST_ID”) field 315; an indicator of whether to roam only on preferred carriers (“PREF_ONLY”) field 320; a default roaming indication (“DEF_ROAM_IND”) field 325; the number of acquisition records included in the acquisition table of the PRL (“NUM_ACQ_RECS”) field 330; and the number of system records included in the system table of the PRL (“NUM_SYS_RECS”) field 335.

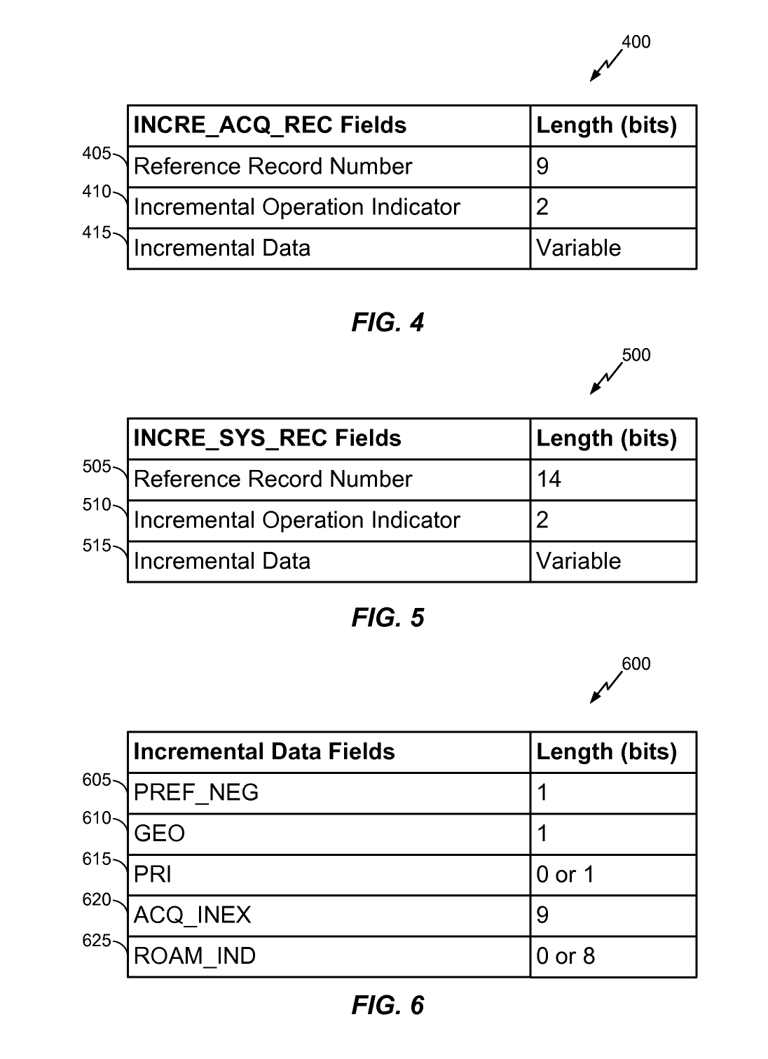

The data structure further includes a second portion 304, which includes the incremental update information for the PRL. The first field (“NUM_INCRE_ACQ_RECS”) field 340 of the second portion 304 identifies the number of acquisition records of the acquisition table that are to be updated according to the data structure. The second field (“NUM_INCRE_SYS_RECS”) field 345 of the second portion 304 identifies the number of system records of the system table that are to be updated according to the data structure. The third field (“INCRE_ACQ_TABLE”) field 350 includes the actual data for updating the acquisition table of the PRL as well as an indication of how to update the PRL as discussed with respect to FIG. 4. The fourth field (“INCRE_SYS_TABLE”) field 355 includes the actual data for updating the system table of the PRL as well as an indication of how to update the PRL as discussed with respect to FIG. 5.

The data structure further includes a third portion 306, which includes a first field (“RESERVED (for NEW PRL)”) field 360 including reserved bits for byte alignment and a second field (“PR_LIST_CRC”) field 365 including data for performing a cyclic redundancy checks (CRC). The third portion 306 also includes a third field (“RESERVED (for Incremental PRL)”) field 370 including a second set of reserved bits to make the entire data structure equal to an integer number of octets.

FIG. 4 illustrates a table 400 that represents a portion of the data structure represented by the table 300 of FIG. 3. As discussed with respect to FIG. 3, the INCRE_ACQ_TABLE field 350 of the data structure includes the actual data for updating the acquisition table of the PRL as well as an indication of how to update the PRL. The INCRE_ACQ_TABLE field 350 includes a number of incremental acquisition records (indicated by the NUM_INCRE_ACQ_RECS field 340), which are each represented by the table 400. Each incremental acquisition record includes the data that is used for updating a single acquisition record of the PRL. As shown in table 400, in one exemplary implementation, each incremental acquisition record is made up of 3 fields. The first field “reference record number” field 405 indicates the record number or sequence number of the acquisition record in the PRL that is to be modified. The second field “incremental operation indicator” field 410 indicates which operation is to be performed on the indicated record. For example, ‘00’ may indicate deletion of the record; ‘01’ may indicate insertion of a new record before the indicated record (such as included in the “incremental data” field 415); ‘10’ may indicate replacement of the record with a new record (such as included in the “incremental data” field 415); and ‘11’ may be reserved for some other use. The third field “incremental data” field 415 includes a new record to be added or replace an existing record with if the associated operation is an insertion or a replacement. Alternatively, if the associated operation is a deletion or some other operation not requiring new data, the data in the incremental data field 415 may be NULL, as in not included. The AT 106a may utilize the value stored in the NUM_INCRE_ACQ_RECS field 340 to determine how many incremental acquisition records are included in the data structure. Further, for each incremental acquisition record, the AT 106a utilizes the reference record number field 405 to locate in memory the record to modify. The AT 106a then determines which operation to perform at the located record according to the incremental operation indicator field 410 and performs the indicated operation utilizing data from the incremental data field 415. Accordingly, the AT 106a updates the acquisition table of the PRL.

FIG. 5 illustrates a table 500 that represents a portion of the data structure represented by the table 300 of FIG. 3. As discussed with respect to FIG. 3, the INCRE_SYS TABLE field 355 of the data structure includes the actual data for updating the system table of the PRL as well as an indication of how to update the PRL. The INCRE_SYS_TABLE field 355 includes a number of incremental system records (indicated by the NUM_INCRE_SYS_RECS field 345), which are each represented by the table 500. Each incremental system record includes the data that is used for updating a single system record of the PRL. As shown in table 500, in one exemplary implementation, each incremental system record is made up of 3 fields. The first field “reference record number” field 505 indicates the record number or sequence number of the system record in the PRL that is to be modified. The second field “incremental operation indicator” field 510 indicates which operation is to be performed on the indicated record. For example, ‘00’ may indicate deletion of the record; ‘01’ may indicate insertion of a new record before the indicated record (such as included in the “incremental data” field); ‘10’ may indicate replacement of the record with a new record (such as included in the “incremental data” field 515); and ‘11’ may be reserved for some other use or may indicate partial replacement of the record (only update certain fields in the record) such as discussed with respect to FIG. 6. The third field “incremental data” field 515 includes a new record to be added or replace an existing record with if the associated operation is an insertion or a replacement. Alternatively, if the associated operation is a deletion or some other operation not requiring new data, the data in the incremental data field 515 may be NULL, as in not included. The AT 106a may utilize the data in the NUM_INCRE_SYS_RECS field 345 to determine how many incremental system records are included in the data structure. Further, for each incremental system record, the AT 106a utilizes the reference record number field 505 to locate in memory the record to modify. The AT 106a then determines which operation to perform at the located record according to the data in the incremental operation indicator field 510 and performs the indicated operation utilizing data from the incremental data field 515. Accordingly, the AT 106a updates the system table of the PRL.

FIG. 6 illustrates a table 600 that represents a portion of the data structure represented by the table 300 of FIG. 3. As discussed with respect to FIG. 5, the incremental data field 515 of the incremental system records includes data for updating records of the PRL. Table 600 illustrates one embodiment of the incremental data field 515 for updating only a portion of a record. This embodiment of the incremental data field 515 may be used in conjunction with a value in the incremental operation indicator field 510 of ‘11,’ where ‘11’ represents partial modification of a record. The incremental data field 515 represented by table 600 includes only certain fields (PRE_NEG field 605, GEO field 610, PRI field 615, ACQ_INEX field 620, ROAM_IND field 625) of the records in the PRL. Accordingly, only those fields in the located system record are updated with the data included in the incremental data field 515 when the indicator is ‘11.’

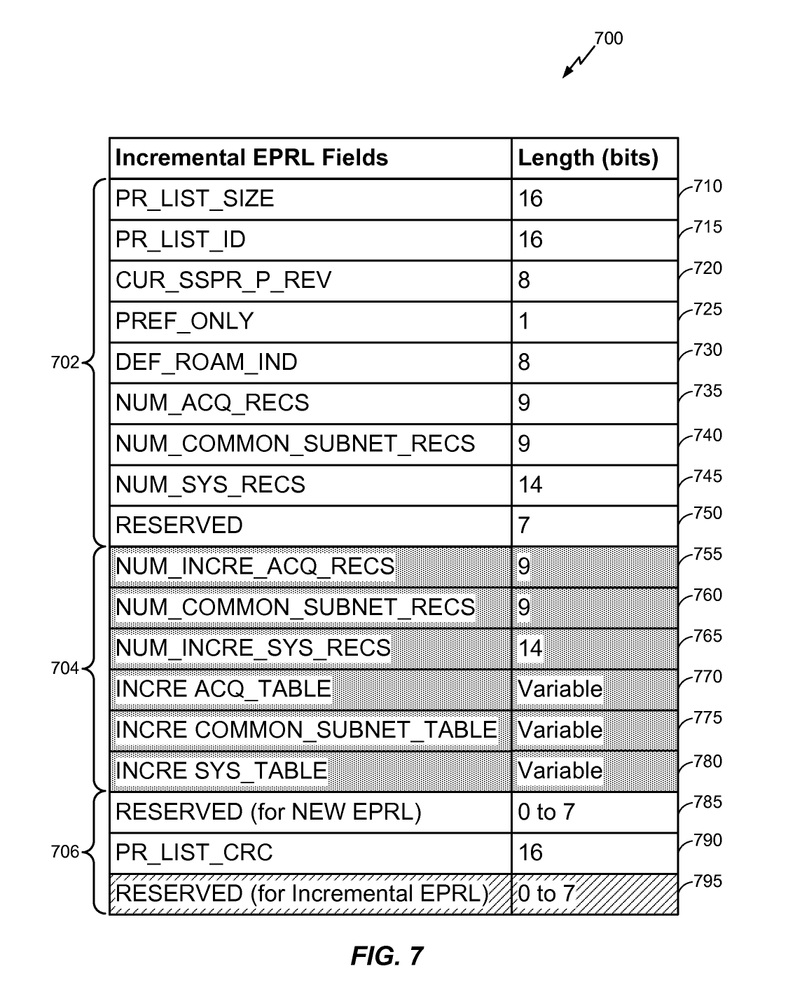

FIG. 7 illustrates a table 700 that represents a data structure that may be transmitted by the node 104 to the AT 106a to update an ePRL stored at the AT 106a. The AT 106a may use the data structure to update the ePRL incrementally by changing data stored on the RUIM card 273 per the instructions contained in the data structure similar to how the data structure described with respect to FIGS. 3-6 is used. Accordingly, only the different information included in the data structure of the ePRL and how that information is utilized is described below. The data structure for updating the ePRL includes the same fields as the data structure described with FIGS. 3-6 including additional fields for updating a common subnet table included in the ePRL. For example, the data structure includes additional fields CUR_SSPR_P_REV field 720, NUM_COMMON_SUBNET_RECS field 740, and RESERVED field 750 in the first portion 702 of the data structure including the header information. The NUM_COMMON_SUBNET_RECS field 740 is used to indicate the number of common subnet records included in the common subnet table of the ePRL. Further, the data structure includes, in the second portion 704 including incremental data, a NUM_INCRE_COMMON_SUBNET_RECS field 760, which identifies the number of common subnet records of the common subnet table that are to be updated according to the data structure. The second portion 704 further includes the INCRE COMMON_SUBNET_TABLE field 775, which includes the actual data for updating the common subnet table of the ePRL as well as an indication of how to update the ePRL as discussed with respect to FIG. 8.

FIG. 8 illustrates a table 800 that represents a portion of the data structure represented by the table 700 of FIG. 7. As discussed with respect to FIG. 7, the INCRE COMMON_SUBNET_TABLE field 775 of the data structure includes the actual data for updating the common subnet table of the ePRL as well as an indication of how to update the ePRL. The INCRE COMMON_SUBNET_TABLE field 775 includes a number of incremental common subnet records (indicated by the NUM_INCRE_COMMON_SUBNET_RECS field 760), which are each represented by the table 800. Each incremental common subnet record includes the data used for updating a single common subnet record of the ePRL. As shown in table 800, in one exemplary implementation, each incremental acquisition record is made up of 3 fields. The first field “reference record number” field 805 indicates the record number or sequence number of the common subnet record in the ePRL that is to be modified. The second field “incremental operation indicator” field 810 indicates which operation is to be performed on the indicated record. For example, ‘00’ may indicate deletion of the record; ‘01’ may indicate insertion of a new record before the indicated record (such as included in the “incremental data” field); ‘10’ may indicate replacement of the record with a new record (such as included in the “incremental data” field 815); and ‘11’ may indicate partial replacement of the record (only certain fields in the record to be updated) or may be reserved for some other use. The third field “incremental data” field 815 includes a new record to be added or replace an existing record with if the associated operation is an insertion or a replacement. Alternatively, if the associated operation is a deletion or some other operation not requiring new data, the value of the incremental data field 815 may be NULL, as in not included. The AT 106a may utilize the data in the NUM_INCRE_COMMON_SUBNET_RECS field 760 to determine how many incremental common subnet records are included in the data structure. Further, for each incremental common subnet record, the AT 106a utilizes the reference record number field 805 to locate in memory the record to modify. The AT 106a then determines which operation to perform at the located record according to the value of the incremental operation indicator field 810 and performs the indicated operation utilizing data from the incremental data field 815. Accordingly, the AT 106a updates the common subnet table of the ePRL.

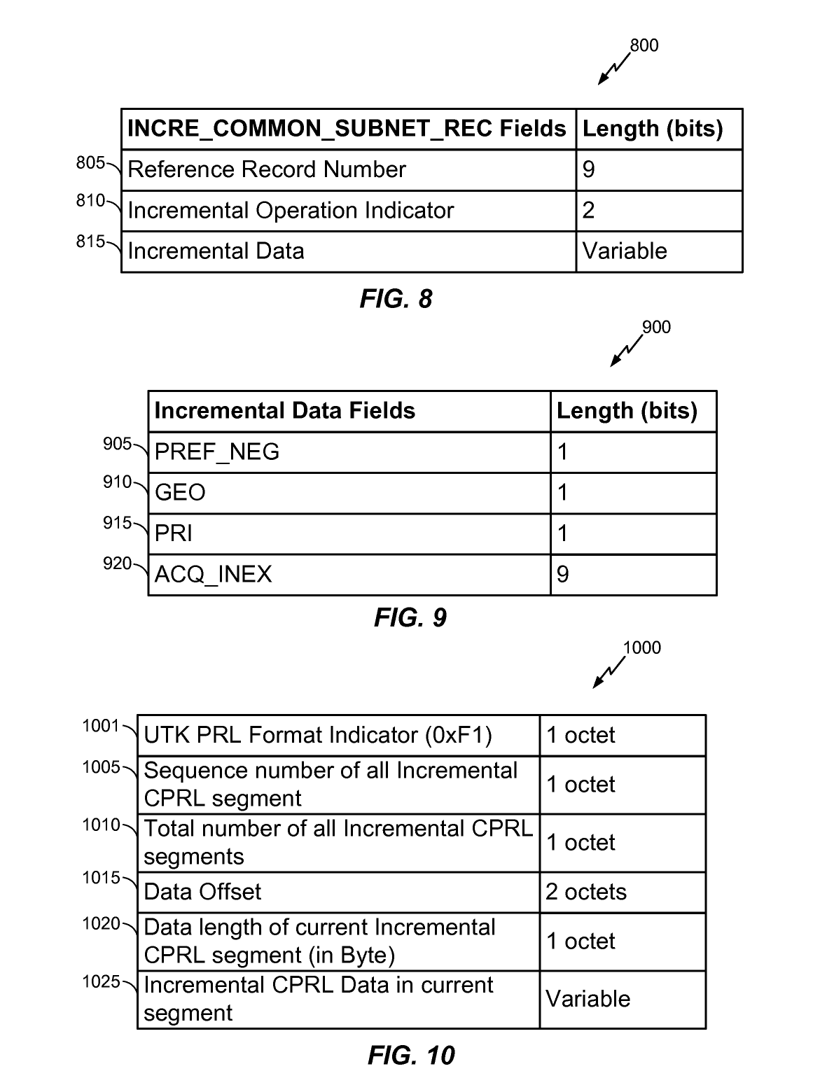

FIG. 9 illustrates a table 900 that represents a portion of the data structure represented by the table 800 of FIG. 8. As discussed with respect to FIG. 5, the incremental data field 515 of the incremental system records includes data for updating records of the PRL. The same type of structure may be used for updating the ePRL according to the data structure described with respect to FIG. 8. Table 900 illustrates one embodiment of the incremental data field 815 for updating only a portion of a record. This embodiment of the incremental data field 815 may be used in conjunction with a value of the incremental operation indicator field 810 of ‘11,’ where ‘11’ represents partial modification of a record. The incremental data field 815 represented by table 900 includes only certain fields (PRE_NEG field 905, GEO field 910, PRI field 915, ACQ_INEX field 920) of the records in the ePRL. Accordingly, only those fields in the located system record are updated with the data included in the incremental data field 815 when the indicator is ‘11.’

In some instances, the AT 106a may store both a PRL and an ePRL. Accordingly, the AT 106a may store the PRL concatenated with the ePRL to form a concatenated PRL (CPRL). To update the PRL and the ePRL the carrier may send to the AT 106a a data structure, an incremental CPRL, concatenating a structure for updating the PRL with a structure for updating the ePRL, along with a set of bits used for performing a CRC (e.g., 16 bits for performing a CRC). Further, the home carrier may need to break up an incremental PRL, ePRL, or CPRL into multiple SMS messages for transmission to the AT 106a via a node 104.

FIG. 10 illustrates a table 1000 that represents the data sent in a single SMS message for performing incremental CPRL update. The incremental CPRL data structure is broken up into a sequence of data segments. Each segment is transmitted in an SMS. As shown, each SMS message includes 6 fields of data. The first field “UTK PRL Format Indicator (0xF1)” field 1001 indicates the type of data structure included in the SMS message (e.g., an incremental update of the format described with respect to FIGS. 3-9) so the AT 106a know how to interpret the data. The second field “Sequence number of current Incremental CPRL segment” field 1005 indicates the order of the segment received in the SMS with respect to other segments that make up the incremental CPRL data structure, so the AT 106a can arrange the segments and determine if any segment is missing. The third field “Total number of all Incremental CPRL segments” field 1010 indicates the total number of segments used to make up the incremental CPRL incremental data structure, so the AT 106a can arrange the segments and determine if any segment is missing. The fourth field “Data Offset” field 1015 is used to help reassemble the incremental CPRL by indicating where the data in this segment is stored with respect to a start position of the data structure of the incremental CPRL. The fifth field “Data length of current Incremental CPRL segment” field 1020 indicates in bytes the length of the data segment included in the SMS. The sixth field “Incremental CPRL Data in current segment” field 1025 includes the actual data segment of the incremental CPRL data structure. The AT 106a utilizes these fields to determine that all data segments for the incremental CPRL are received, and also utilizes the fields to form the CPRL data structure.

FIG. 11 illustrates a table 1100 that represents another data structure that may be transmitted by the node 104 to the AT 106a to update the PRL stored at the AT 106a. The AT 106a may use the data structure to update the PRL incrementally by changing data stored on the RUIM card 273 per the instructions contained in the data structure. The data structure may be a variable number of bits. The table 1100 indicates what the bits in the data structure represent. For example, the first 64 bits of the data structure include new header information for the data structure that is represented by a first portion 1102. The header information includes different fields as shown in first portion 1102. For example, the first field of the header information defines the size of the PRL and is referred to by the field name PR_LIST_SIZE field 1110. Further, as shown in table 1100, the PR_LIST_SIZE field 1110 is made up of 16 bits. The remaining fields of the header information, as shown in the first portion 1102, define: an identifier of the PRL to be updated (“PRL_LIST_ID”) field 1115; an indicator of whether to roam only on preferred carriers (“PREF_ONLY”) field 1120; a default roaming indication (“DEF_ROAM_IND”) field 1125; the number of acquisition records included in the acquisition table of the PRL (“NUM_ACQ_RECS”) field 1130; and the number of system records included in the system table of the PRL (“NUM_SYS_RECS”) field 1135.

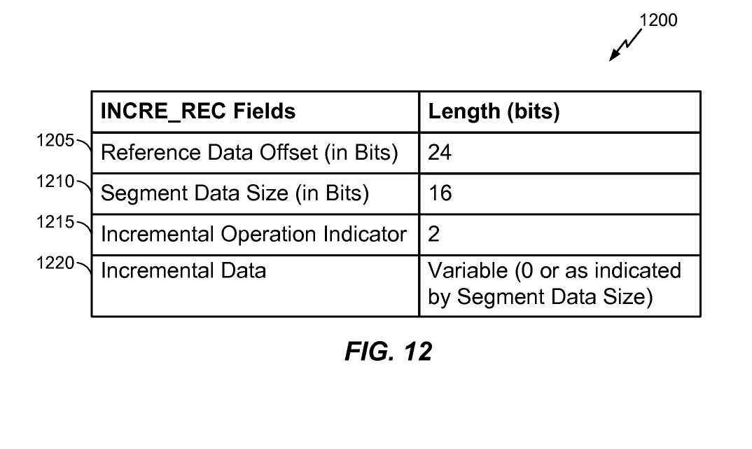

The data structure further includes a second portion 1104, which includes the incremental update information for the PRL. The first field (“NUM_INCRE_RECS”) field 1140 of the second portion 1104 identifies the number of records (of any type) of the PRL that are to be updated according to the data structure. The second field (“INCRE_TABLE”) field 1145 includes the actual data for updating the records of the PRL as well as an indication of how to update the PRL as discussed with respect to FIG. 12.

The data structure further includes a third portion 1106, which includes a first field (“RESERVED (for NEW PRL)”) field 1150 including reserved bits for byte alignment and a second field (“PR_LIST_CRC”) field 1155 including data for performing a cyclic redundancy checks (CRC). The third portion 1106 also includes a third field (“RESERVED (for Incremental PRL)”) field 1160 including a second set of reserved bits to make the entire data structure equal to an integer number of octets.

FIG. 12 illustrates a table 1200 that represents a portion of the data structure represented by the table 1100 of FIG. 11. As discussed with respect to FIG. 11, the INCRE_TABLE field 1145 of the data structure includes the actual data for updating the PRL as well as an indication of how to update the PRL. The INCRE_TABLE field 1145 includes a number of incremental records (indicated by the NUM_INCRE_RECS field 1140), which are each represented by the table 1200. Each incremental record includes the data used for updating a piece of data in the stored PRL. As shown in table 1200, in one exemplary implementation, each incremental record is made up of 4 fields. The first field “reference data offset” field 1205 indicates in bits the position or offset in bits from the beginning of the PRL data (which is stored in the RUIM card 273) to begin modifying data. The second field “segment data size” field 1210 in bits, indicates the number of bits including the beginning position to modify. The third field “incremental operation indicator” field 1215 indicates which operation is to be performed on the indicated data position. For example, ‘00’ may indicate deletion of the piece of data; ‘01’ may indicate insertion of a new piece of data before the indicated position (such as included in the “incremental data” field 1220); ‘10’ may indicate replacement of the piece of data with a new data (such as included in the “incremental data” field 1220); and ‘11’ may be reserved for some other use. The fourth field “incremental data” field 1220 includes a new piece of data to be added or replace an existing data with if the associated operation is an insertion or a replacement. The incremental data field 1220 is of the length specified by the segment data size field 1210 if there is new data to be added or replaced. Alternatively, if the associated operation is a deletion or some other operation not requiring new data, the data in the incremental data field 1220 may be NULL, as in not included. The AT 106a may utilize the data in the NUM_INCRE_RECS field 1140 to determine how many incremental records are included in the data structure. Further, for each incremental record, the AT 106a utilizes the reference data offset field 1205 to locate in memory the data position to modify and utilizes the segment data size field 1210 to determine until what point to modify data. The AT 106a then determines which operation to perform at the located record according to the data in the incremental operation indicator field 1215 and performs the indicated operation utilizing data from the incremental data field 1220. Accordingly, the AT 106a updates the PRL.

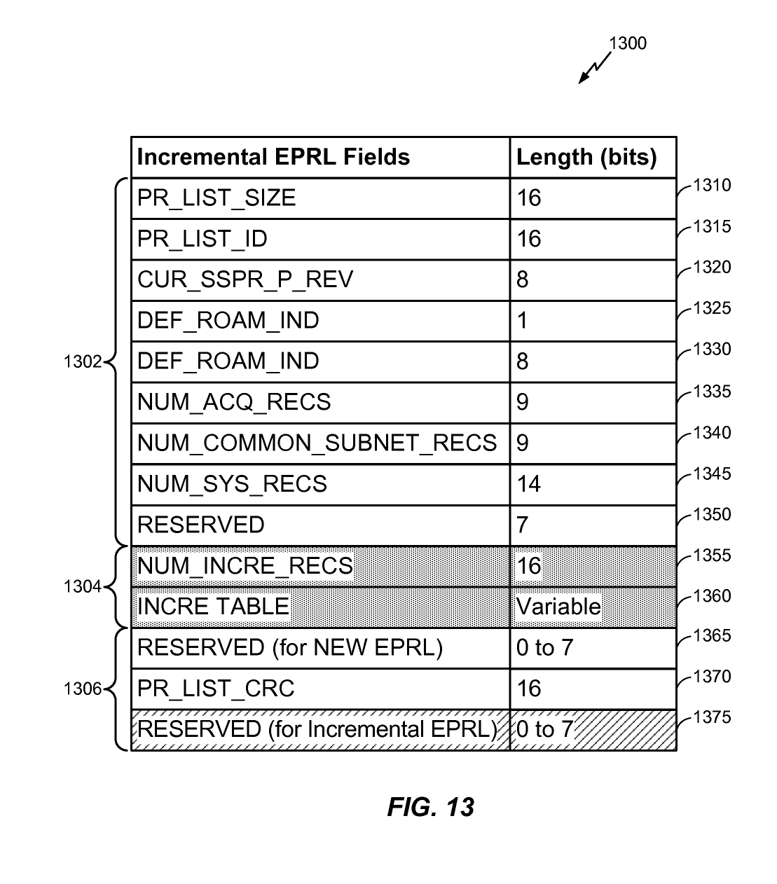

FIG. 13 illustrates a table 1300 that represents another data structure that may be transmitted by the node 104 to the AT 106a to update an ePRL stored at the AT 106a. The AT 106a may use the data structure to update the ePRL incrementally by changing data stored on the RUIM card 273 per the instructions contained in the data structure similar to how the data structure described with respect to FIGS. 11-12 is used. Accordingly, only the different information included in the data structure of the ePRL and how that information is utilized is described below. The data structure for updating the ePRL includes the same fields as the data structure described with FIGS. 11-12 including additional fields. For example, the data structure includes additional fields CUR_SSPR_P_REV field 1320, NUM_COMMON_SUBNET_RECS field 1340, and RESERVED field 1350 in the first portion 1302 of the data structure including the header information. The NUM_COMMON_SUBNET_RECS field 1340 is used to indicate the number of common subnet records included in the common subnet table of the ePRL.

In some instances, the AT 106a may store both a PRL and an ePRL. Accordingly, the AT 106a may store the PRL concatenated with the ePRL to form a concatenated PRL (CPRL). To update the PRL and the ePRL the carrier may send to the AT 106a a data structure, an incremental CPRL, concatenating a structure for updating the PRL with a structure for updating the ePRL, along with a set of bits used for performing a CRC (e.g., 16 bits for performing a CRC). Further, the home carrier may need to break up an incremental PRL, ePRL, or CPRL into multiple SMS messages for transmission to the AT 106a via a node 104. The incremental CPRL may be transmitted and used at the AT 106a similar to as described above with respect to FIG. 10. However, the UTK PRL Format Indicator may have a different value (e.g., 0xF2) to indicate the data structure is of a different type for updating the CPRL.

FIG. 14 illustrates a table 1400 that represents yet another data structure that may be transmitted by the node 104 to the AT 106a to update a PRL, ePRL, or CPRL stored at the AT 106a. The AT 106a may use the data structure to update the PRL, ePRL, or CPRL incrementally by changing data stored on the RUIM card 273 per the instructions contained in the data structure. The data structure may be a variable number of bits. The table 1400 indicates what the bits in the data structure represent.

The data structure includes a first portion 1404, which includes the incremental update information for the PRL, ePRL, or CPRL. The first field (“NUM_INCRE_RECS”) field 1410 of the first portion 1404 identifies the number of incremental records in the INCRE_TABLE field 1415 that are to be used to update the data in the PRL, ePRL, or CPRL according to the data structure. The second field (“INCRE_TABLE”) field 1415 includes the actual data for updating the records of the PRL, ePRL, or CPRL as well as an indication of how to update the PRL, ePRL, or CPRL as discussed with respect to FIG. 15.

The data structure further includes a second portion 1406, which includes a first field (“RESERVED”) field 1420 including reserved bits to make the entire data structure equal to an integer number of octets and a second field (“PR_LIST_CRC”) field 1425 including data for performing a cyclic redundancy checks (CRC) on the generated PRL, ePRL, or CPRL to make sure it is corresponds to the stored PRL, ePRL, or CPRL. The second portion 1406 also includes a third field (“CRC”) field 1430 including data for performing a cyclic redundancy checks (CRC) on the received data structure to make sure it is received correctly.

FIG. 15 illustrates a table 1500 that represents a portion of the data structure represented by the table 1400 of FIG. 14. As discussed with respect to FIG. 14, the INCRE_TABLE field 1415 of the data structure includes the actual data for updating the PRL, ePRL, or CPRL as well as an indication of how to update the PRL, ePRL, or CPRL. The INCRETABLE field 1415 includes a number of incremental records (indicated by the NUM_INCRE_RECS field 1410), which are each represented by the table 1500. Each incremental record includes the data used for updating a piece of data in the PRL, ePRL, or CPRL. As shown in table 1500, in one exemplary embodiment, each incremental record is made up of 4 fields. The first field “reference data offset” 1505 indicates in bits the position or offset in bits from the beginning of the PRL, ePRL, or CPRL (which is stored on the RUIM card 273) to begin modifying data. The second field “segment data size” 1510 in bits, indicates the number of bits including the beginning position to modify. The third field “incremental operation indicator” field 1515 indicates which operation is to be performed on the indicated data. For example, ‘00’ may indicate deletion of the piece of the data; ‘01’ may indicate insertion of a new piece of data before the indicated data position (such as included in the “incremental data” field 1520); ‘10’ may indicate replacement of the piece of data with a new record (such as included in the “incremental data” field 1520); and ‘11’ may be reserved for some other use. The fourth field “incremental data” field 1520 includes a new piece of data to be added or replace an existing data with if the associated operation is an insertion or a replacement. The incremental data field 1520 is of the length specified by the segment data size field 1510 if there is new data to be added or replaced. Alternatively, if the associated operation is a deletion or some other operation not requiring new data, the data in the incremental data field 1520 may be NULL, as in not included. The AT 106a may utilize the data in the NUM_INCRE_RECS field 1410 to determine how many incremental records are included in the data structure. Further, for each incremental record, the AT 106a utilizes the reference data offset field 1505 to locate in memory the data position to modify and utilizes the segment data size field 1510 to determine until what point to modify data. The AT 106a then determines which operation to perform at the located data according to the incremental operation indicator field 1515 and performs the indicated operation utilizing data from the incremental data field 1520. Accordingly, the AT 106a updates the PRL, ePRL, or CPRL.

The home carrier may need to break up an incremental PRL, ePRL, or CPRL into multiple SMS messages for transmission to the AT 106a via a node 104. The incremental PRL, ePRL, or CPRL may be transmitted and used at the AT 106a similar to as described above with respect to FIG. 10. However, the UTK PRL Format Indicator may have a different value (e.g., 0xF3) to indicate the data structure is of a different type for updating the PRL, ePRL, or CPRL. Further, in the method described with respect to FIGS. 14-15, the headers of the new PRL, ePRL, or CPRL may be sent together with the first piece of new data in only one incremental record, such as by using the data structures described with respect to FIGS. 11-13. Accordingly, header data can be updated together with other data, thus reducing the overhead and the amount of data transmitted.

As compared with the methods described with respect to FIGS. 3-10, the methods of FIGS. 11-13 and 14-15 allow records to be updated at arbitrary locations, and further allow multiple sequential records to be updated by utilizing only a single Incremental Record, as the update information may have a length spanning several records. Further, the methods described above with respect to FIGS. 3-15 each may require a server (PRL server) controlled by the home carrier to be configured to send the appropriate information as discussed above to the AT 106a via the node 104. The server may be any computing device. Further, the server may comprise a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. The server may also be implemented as a combination of computing devices, e.g., a combination of a DSP and a microprocessor, a plurality of microprocessors, one or more microprocessors in conjunction with a DSP communication, or any other such configuration.

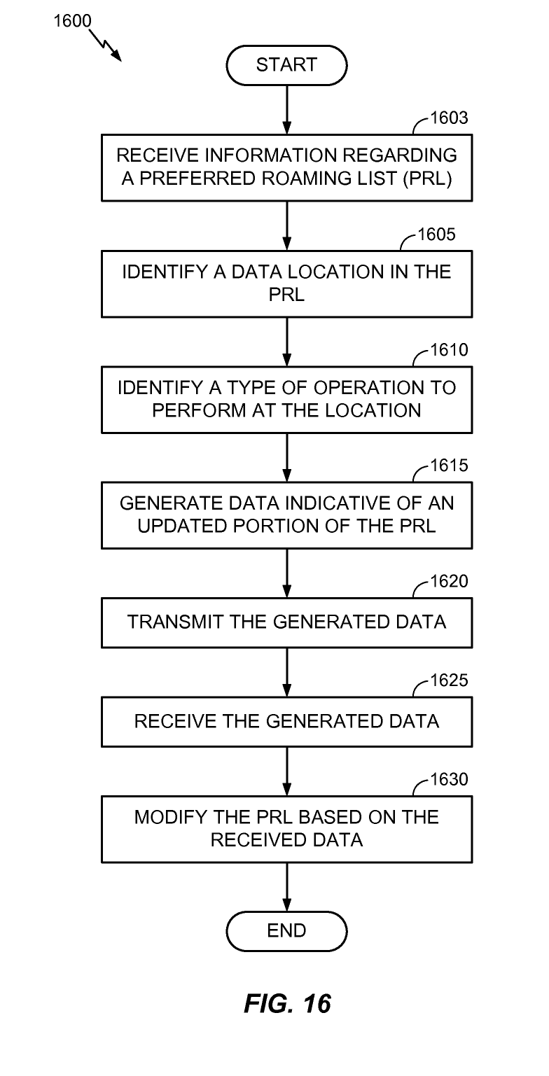

FIG. 16 is a flowchart of an exemplary process for updating the PRL, ePRL, and/or CPRL of the AT 106a. At a step 1603, the home carrier server receives information regarding a PRL, ePRL, and/or CPRL stored at the AT 106a. In one embodiment the home carrier server receives the PRL, ePRL, and/or CPRL from the AT 106a. Alternatively, the home carrier server retrieves the PRL, ePRL, and/or CPRL from a database. At a step 1605, the home carrier server identifies one or more data locations in the PRL, ePRL, and/or CPRL that has data to be updated. For example, the home carrier server compares the received PRL, ePRL, and/or CPRL to a new PRL, ePRL, and/or CPRL. Continuing at a step 1610, the home carrier server identifies one or more types of operations (add, delete, update, etc.) to perform at one or more identified data locations. Further at a step 1615, the home carrier server generates data indicative of an updated portion of the PRL, ePRL, and/or CPRL that corresponds to the identified data locations and operations. For example, the home carrier server may generate data structures such as those described above with respect to FIGS. 3-15 based on the data of the PRL, ePRL, and/or CPRL to be modified. Next at a step 1620, the home carrier server transmits the generated data to the AT 106a via the node 104.

Continuing at a step 1625, the AT 106a receives the generated data. Further, at a step 1630, the AT 106a modifies the PRL, ePRL, and/or CPRL based on the received generated data. For example, the AT 106a may utilize received data structures and modify the PRL, ePRL, and/or CPRL as discussed above with respect to FIGS. 3-15.

As discussed above, another embodiment for incrementally updating a PRL, ePRL, and/or CPRL may be implemented by configuring the RUIM card 273 to understand one or more operators such as a store operator, a move operator, a bit shift operator, a commit operator, a loop operator etc. By utilizing these operators, data can be modified (e.g., added, deleted, updated, etc.) at the RUIM card 273.

The home carrier may send the operators to the AT 106a via the node 104. The home carrier may also send data along with the operator, such as where the operator is a store operator that stores the data sent with the operator. The RUIM card 273 executes the operators. By executing the operators, the memory in the RUIM card 273 that stores the PRL, ePRL, and/or CPR is updated according to the order of the operators and can be done so incrementally.

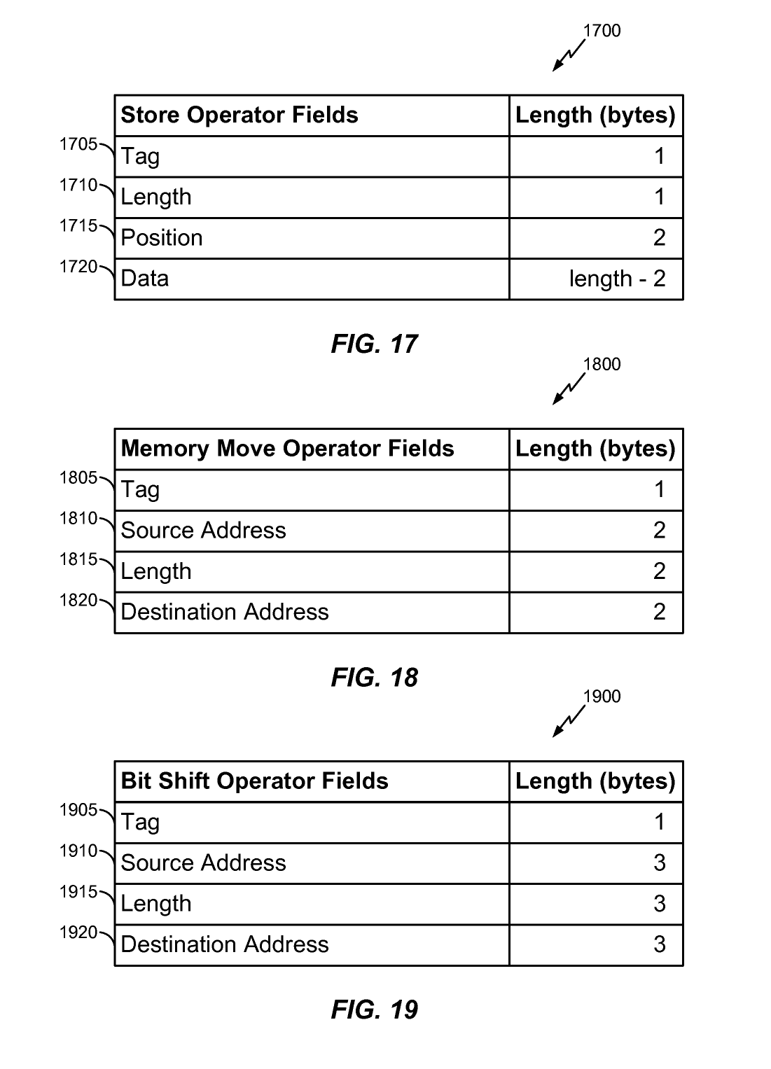

FIG. 17 illustrates a table 1700 that represents a store operator executable by the RUIM card 273. The store operator is used to store data in the RUIM card 273. The store operator is made up of a “Tag” field 1705, a “Length” field 1710, a “Position” field 1715, and a “Data” field 1720. The Tag field 1705 may have a length of 1 byte, the Length field 1710 may have a length of 1 byte, the Position field 1715 may have a length of 2 bytes, and the data field 1720 may have a length equal to the value of the Length field 1710 minus 2 bytes. The RUIM card 273 may identify the operator as a store operator based on the Tag field 1705 having a value associated with a store operator (e.g., 0x01). The RUIM card 273 may further identify the length of data to be stored as equal to the value of the Length field 1710. The RUIM card 273 may further identify the position in the memory of the RUIM card 273 where the data is to be stored based on the Position field 1715. Finally, the data to be written to the RUIM card 273 at the given position may be found in the Data field 1720 of the store operator. For example, if the RUIM card 273 receives the bit stream 0103000125, the RUIM 273 may execute a command to store, starting at byte position 0001 of the PRL, the value 0x25.

FIG. 18 illustrates a table 1800 that represents a memory move operator executable by the RUIM card 273. The memory move operator is used to copy data at the byte level from one location to another in the RUIM card 273. The memory move operator is made up of a “Tag” field 1805, a “Source Address” field 1810, a “Length” field 1815, and a “Destination” field 1820. The Tag field 1805 may have a length of 1 byte, the Source Address field 1810 may have a length of 2 bytes, the Length field 1815 may have a length of 2 bytes, and the Destination Address field 1820 may have a length of 2 bytes. The RUIM card 273 may identify the operator as a memory move operator based on the Tag field 1805 having a value associated with a memory move operator (e.g., 0x02). The RUIM card 273 may further identify the starting position in the memory of the RUIM card 273 where the data to be copied is located based on the Source Address field 1810. The RUIM card 273 may further identify the length of data to be copied as equal to the value of the Length field 1815. Finally, the RUIM card 273 may further identify the position in the memory of the RUIM card 273 where the data is to be copied based on the Destination Address field 1820. For example, if the RUIM card 273 receives the bit stream 021E4F181025, the RUIM 273 may execute a command to copy the 0x18 bytes of data starting at position 0x1E4F to position 0x1025.

FIG. 19 illustrates a table 1900 that represents a bit shift operator executable by the RUIM card 273. The bit shift operator is used to copy data at the bit level from one location to another in the RUIM card 273. The bit shift operator is made up of a “Tag” field 1905, a “Source Address” field 1910, a “Length” field 1915, and a “Destination” field 1920. The Tag field 1905 may have a length of 1 byte, the Source Address field 1910 may have a length of 3 bytes, the Length field 1915 may have a length of 3 bytes, and the Destination Address field 1920 may have a length of 3 bytes. The RUIM card 273 may identify the operator as a bit shift operator based on the Tag field 1905 having a value associated with a bit shift operator (e.g., 0x03). The RUIM card 273 may further identify the starting position in the memory of the RUIM card 273 where the data to be copied is located based on the Source Address field 1910. The RUIM card 273 may further identify the length of data to be copied as equal to the value of the Length field 1915. Finally, the RUIM card 273 may further identify the position in the memory of the RUIM card 273 where the data is to be copied based on the Destination Address field 1920. For example, if the RUIM card 273 receives the bit stream 03001902000010001901, the RUIM 273 may execute a command to copy the 0x10 bits of data starting at the 2^{nd} bit of position 0x0019 to the 1^{st} bit of position 0x0019.

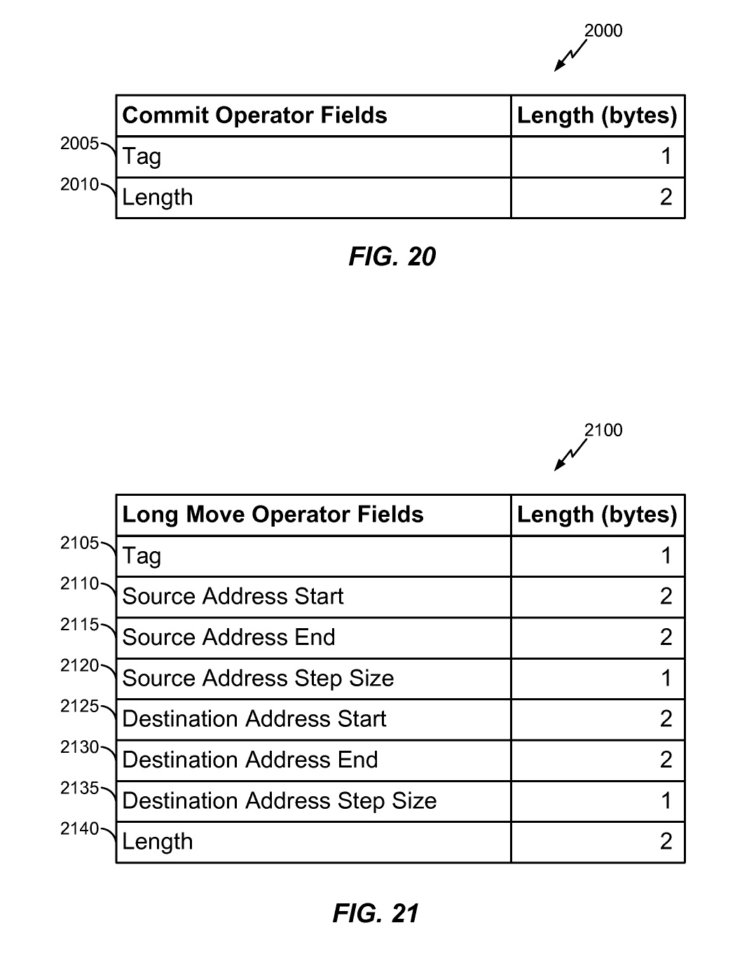

FIG. 20 illustrates a table 2000 that represents a commit operator executable by the RUIM card 273. The commit operator is used to move data from a buffer to the memory of the RUIM card 273. The commit operator is made up of a “Tag” field 2005 and a “Length” field 2010. The Tag field 2005 may have a length of 1 byte and the Length field 2010 may have a length of 2 bytes. The RUIM card 273 may identify the operator as a commit operator based on the Tag field 2005 having a value associated with a commit operator (e.g., 0x04). The RUIM card 273 may further identify length of the data to be moved from a buffer in the RUIM card 273 to the file system of the RUIM card 273 based on the Length field 2010. For example, if the RUIM card 273 receives the bit stream 040025, the RUIM 273 may execute a command to copy 0x25 bytes from the buffer to the memory of the RUIM card 273.

FIG. 21 illustrates a table 2100 that represents a long move operator executable by the RUIM card 273. The long move operator is used to copy data from several locations to several different locations in the RUIM card 273. The long move operator is made up of a “Tag” field 2105, a “Source Address Start” field 2110, a “Source Address End” field 2115, a “Source Address Step Size” field 2120, a “Destination Address Start” field 2125, a “Destination Address End” field 2130, a “Destination Address Step Size” field 2135, and a “Length” field 2140. The Tag field 2105 may have a length of 1 byte, the Source Address Start field 2110 may have a length of 2 bytes, the Source Address End field 2115 may have a length of 2 bytes, the Source Address Step Size field 2120 may have a length of 1 byte, the Destination Address Start field 2125 may have a length of 2 bytes, the Destination Address End field 2130 may have a length of 2 bytes, the Destination Address Step Size field 2135 may have a length of 1 byte, and the Length field 2140 may have a length of 2 bytes. The RUIM card 273 may identify the operator as a long move operator based on the Tag field 2105 having a value associated with a long move operator (e.g., 0x82). Further, the RUIM card 273 is configured to move data of a length indicated in the Length field 2140 from each of the positions starting at a position indicated by the Source Address Start field 2110 up to a position indicated by the Source Address End field 2115, where the positions are separated by an amount indicated by the Source Address Step Size field 2120. The RUIM card 273 is configured to move the data at each respective position to each of the positions starting at a position indicated by the Destination Address Start field 2125 up to a position indicated by the Destination Address End field 2130, where the positions are separated by an amount indicated by the Destination Address Step Size field 2135. For example, if the RUIM card 273 receives the bit stream 82196119730619711987080004, the RUIM card 273 copies 4 bytes starting at 0x1961 to 0x1971, 4 bytes starting at 0x(1961+6) to 0x(1971+8), and 4 bytes starting at 0x(1961+6*2) to 0x(1971+8*2).

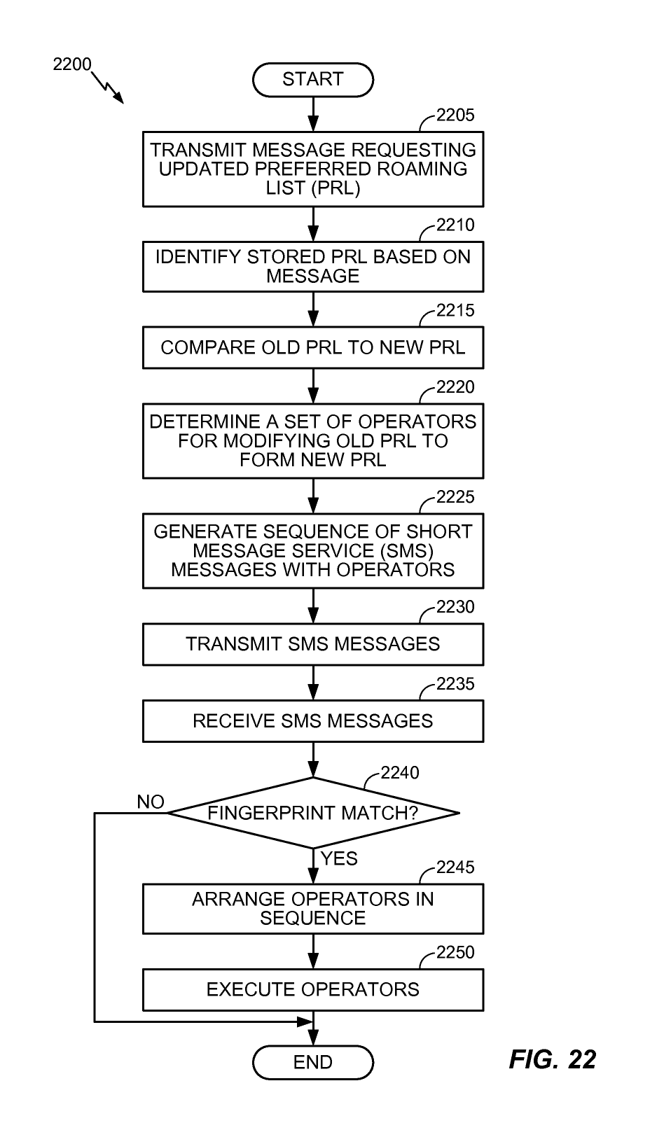

FIG. 22 is a flowchart of an exemplary process for updating the PRL, ePRL, and/or CPRL of the AT 106a. At a step 2205, the AT 106a may send a message to the home carrier server via the node 104 to request an updated PRL, ePRL, and/or CPRL. As part of the message, the AT 106a may include a “fingerprint” that identifies to the home carrier server, which PRL, ePRL, and/or CPRL stored at the home carrier server is associated with the AT 106a. The home carrier server may store PRL, ePRL, and/or CPRL information for several ATs. Accordingly, further at a step 2210, the home carrier server may identify stored PRL, ePRL, and/or CPRL data by utilizing the fingerprint. The fingerprint may comprise a portion of the CRC information (e.g., the last 4 bytes of the CRC) associated with the PRL, ePRL, and/or CPRL stored at the AT 106a. The home carrier server may then find the associated PRL, ePRL, and/or CPRL stored at the home carrier server by locating the PRL, ePRL, and/or CPRL with the same fingerprint. Alternatively to steps 2205-2210, the home carrier server may initiate an update for the PRL, ePRL, and/or CPRL of the AT 106a.

Further, at a step 2215, the home carrier server may then compare the old PRL, ePRL, and/or CPRL of the AT 106a which is stored in the server, to a new PRL, ePRL, and/or CPRL using a diff, merge, and/or compare tool (e.g., Araxis Merge, IDM UltaCompare, etc.). Continuing at a step 2220, the home carrier server determines a set of operators that when executed modify the old PRL, ePRL, and/or CPRL to have the same information as the new PRL, ePRL, and/or CPRL. For example, the home carrier server may form a sequence of operators such as those discussed herein. The home carrier server may optimize the selection of operators so as to reduce the number of operators sent to update the PRL, ePRL, and/or CPRL at the AT 106a. For example, the home carrier server may comprise a PRL analyzer. The PRL analyzer may identify the source address of data in the in the old PRL, ePRL, and/or CPRL that is located in a new destination address in the new PRL, ePRL, and/or CPRL. The PRL analyzer may further generate operators (e.g., memory move, bit shift, long move, etc.) to copy data from the source address to the destination address. Further, the PRL analyzer may further generate operators (e.g., store) to insert new data from the new PRL, ePRL, and/or CPRL into the old PRL, ePRL, and/or CPRL. The PRL analyzer may further calculate the size of the new PRL and generate a commit operator with the indicated size.

Further, at a step 2225, the home carrier server may split the generated operators into a sequence of SMS messages, each message including one or more operators. For example, each SMS message may include a header of 7 bytes, followed by one or more operators in sequence. The header may include a first byte that indicates the sequence number of the SMS message. The header may include a second byte that indicates the protocol version of the operators. The header may further include a third byte that indicates the length of the operators. The header may also include a fourth byte that includes the fingerprint of the PRL, ePRL, and/or CPRL of the AT 106a to be updated.

Continuing at a step 2230, the home carrier server transmits the SMS messages to the AT 106a via the node 104. The AT 106a receives the SMS messages at a step 2235. At a step 2240, the AT 106a determines whether the fingerprint in each SMS message matches the fingerprint of the PRL, ePRL, and/or CPRL stored at the AT 106a. If at the step 2240, the AT 106a determines the fingerprint does not match, the process ends. If at the step 2240, the AT 106a determines the fingerprint does match, the process continues to a step 2245.

At the step 2245, the AT 106a arranges the operators in sequence based on the sequence number of each SMS message. Further at a step 2250, the RUIM card 237 on the AT 106a executes the operators in sequence, thus updating the PRL, ePRL, and/or CPRL.

One or ordinary skill in the art should recognize that various steps may by added or omitted from the processes described with respect to FIGS. 16 and 22. Further, the various steps of the processes may be performed in a different order than described above.

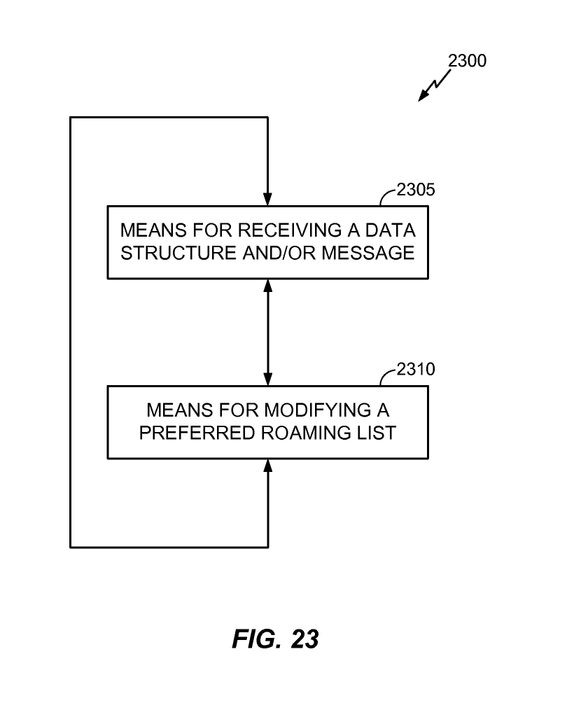

FIG. 23 illustrates a functional block diagram of another exemplary access terminal 106a shown in FIG. 1. Device 2300 comprises means 2305 and 2310 for performing the various actions discussed with respect to FIGS. 3-22.

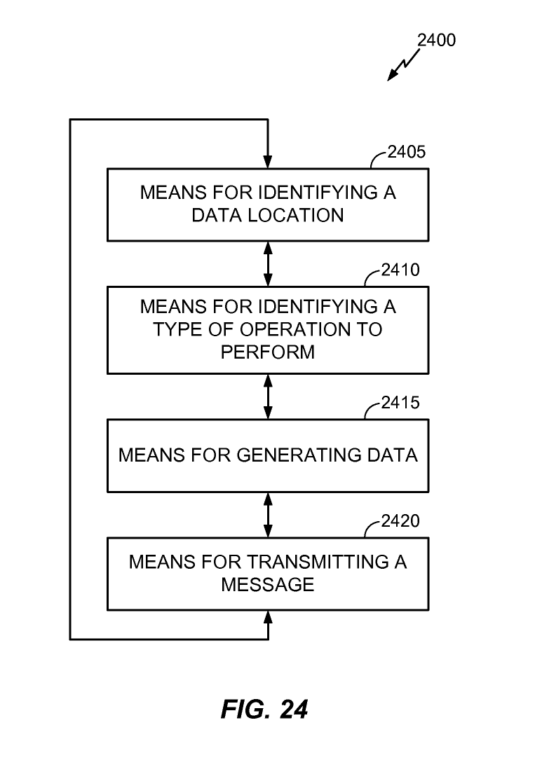

FIG. 24 illustrates a functional block diagram of a home carrier server. Device 2400 comprises means 2405, 2410, 2415, and 2420 for performing the various actions discussed with respect to FIGS. 3-22.

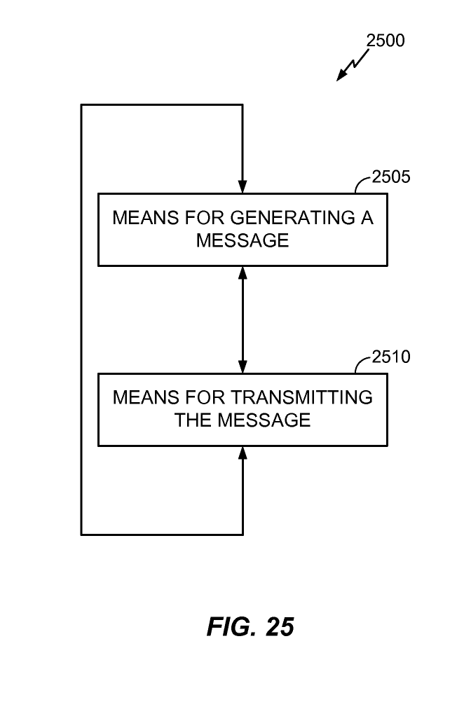

FIG. 25 illustrates a functional block diagram of another home carrier server. Device 2500 comprises means 2505 and 2510 for performing the various actions discussed with respect to FIGS. 3-22.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP communication, or any other such configuration.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A communication apparatus configured to update a preferred roaming list in a mobile device, the apparatus comprising:
a processor configured to:
identify a data location in the preferred roaming list;
identify a type of operation to perform with respect to the identified data location; and
generate data indicative of an updated portion of the preferred roaming list; and
a transmitter configured to transmit a message indicative of the data location, the type of operation, and the data to a mobile device.

2. The apparatus of claim 1, wherein the type of operation is at least one of the following: deletion, insertion, replacement, and partial replacement.

3. The apparatus of claim 1, wherein the message comprises a plurality of short message service messages.

4. The apparatus of claim 1, wherein the preferred roaming list is a concatenated preferred roaming list.

5. The apparatus of claim 1, wherein the preferred roaming list is an extended preferred roaming list.

6. The apparatus of claim 1, wherein the generated data does not include a header.

7. A communication apparatus configured to update a preferred roaming list in a mobile device, the apparatus comprising:
a receiver configured to receive a data structure comprising:
an indicator of a data location to modify the preferred roaming list;
an indicator of a type of operation to perform; and
an updated portion of the preferred roaming list; and
a processor configured to modify the preferred roaming list based on the data structure.

8. The apparatus of claim 7, wherein the type of operation is at least one of the following: deletion, insertion, replacement, and partial replacement.

9. The apparatus of claim 7, wherein the received data is received in a plurality of short message service messages.

10. The apparatus of claim 7, wherein the preferred roaming list is a concatenated preferred roaming list.

11. The apparatus of claim 7, wherein the preferred roaming list is an extended preferred roaming list.

12. A communication apparatus configured to update a preferred roaming list in a mobile device, the apparatus comprising:
a processor configured to generate a message comprising one or more indicators of one or more operators executable by a removable user identity module (RUIM) card, wherein the one or more operators are configured to modify a preferred roaming list; and
a transmitter configured to transmit the message to a mobile device.

13. The apparatus of claim 12, wherein the type of operation is at least one of the following: move, store, bit shift, commit, and copy.

14. The apparatus of claim 12, wherein the message comprises a plurality of short message service messages.

15. The apparatus of claim 12, wherein the preferred roaming list is a concatenated preferred roaming list.

16. The apparatus of claim 12, wherein the preferred roaming list is an extended preferred roaming list.

17. A communication apparatus configured to update a preferred roaming list in a mobile device, the apparatus comprising:
a receiver configured to receive a message comprising one or more indicators of one or more operators executable by a removable user identity module (RUIM) card, wherein the one or more operators are configured to modify a preferred roaming list; and
a processor configured to modify the preferred roaming list based on the one or more operators.

18. The apparatus of claim 17, wherein the type of operation is at least one of the following: move, store, bit shift, commit, and copy.

19. The apparatus of claim 17, wherein the message comprises a plurality of short message service messages.

20. The apparatus of claim 17, wherein the preferred roaming list is a concatenated preferred roaming list.

21. The apparatus of claim 17, wherein the preferred roaming list is an extended preferred roaming list.

22. A method for updating a preferred roaming list in a mobile device, the method comprising:
identifying a data location in the preferred roaming list;
identifying a type of operation to perform with respect to the identified data location;
generating data indicative of an updated portion of the preferred roaming list; and
transmitting a message indicative of the data location, the type of operation, and the data to a mobile device.

23. The method of claim 22, wherein the type of operation is at least one of the following: deletion, insertion, replacement, and partial replacement.

24. The method of claim 22, wherein the message comprises a plurality of short message service messages.

25. The method of claim 22, wherein the preferred roaming list is a concatenated preferred roaming list.

26. The method of claim 22, wherein the preferred roaming list is an extended preferred roaming list.

27. The method of claim 22, wherein the generated data does not include a header.

28. A method for updating a preferred roaming list in a mobile device, the method comprising:
receiving a data structure comprising:
an indicator of a data location to modify the preferred roaming list;
an indicator of a type of operation to perform; and
an updated portion of the preferred roaming list; and
modifying the preferred roaming list based on the data structure.

29. The method of claim 28, wherein the type of operation is at least one of the following: deletion, insertion, replacement, and partial replacement.

30. The method of claim 28, wherein receiving the data structure comprises receiving the data structure in a plurality of short message service messages.

31. The method of claim 28, wherein the preferred roaming list is a concatenated preferred roaming list.

32. The method of claim 28, wherein the preferred roaming list is an extended preferred roaming list.

33. A method for updating a preferred roaming list in a mobile device, the method comprising:
generating a message comprising one or more indicators of one or more operators executable by a removable user identity module (RUIM) card, wherein the one or more operators are configured to modify a preferred roaming list; and
transmitting the message to a mobile device.

34. The method of claim 33, wherein the type of operation is at least one of the following: move, store, bit shift, commit, and copy.

35. The method of claim 33, wherein the message comprises a plurality of short message service messages.

36. The method of claim 33, wherein the preferred roaming list is a concatenated preferred roaming list.

37. The method of claim 33, wherein the preferred roaming list is an extended preferred roaming list.

38. A method for updating a preferred roaming list in a mobile device, the method comprising:
receiving a message comprising one or more indicators of one or more operators executable by a removable user identity module (RUIM) card, wherein the one or more operators are configured to modify a preferred roaming list; and
modifying the preferred roaming list based on the one or more operators.

39. The method of claim 38, wherein the type of operation is at least one of the following: move, store, bit shift, commit, and copy.

40. The method of claim 38, wherein the message comprises a plurality of short message service messages.

41. The method of claim 38, wherein the preferred roaming list is a concatenated preferred roaming list.

42. The method of claim 38, wherein the preferred roaming list is an extended preferred roaming list.

43. A communication apparatus configured to update a preferred roaming list in a mobile device, the apparatus comprising:
means for identifying a data location in the preferred roaming list;
means for identifying a type of operation to perform with respect to the identified data location;
means for generating data indicative of an updated portion of the preferred roaming list; and
means for transmitting a message indicative of the data location, the type of operation, and the data to a mobile device.

44. The apparatus of claim 43, wherein the type of operation is at least one of the following: deletion, insertion, replacement, and partial replacement.

45. The apparatus of claim 43, wherein the message comprises a plurality of short message service messages.

46. The apparatus of claim 43, wherein the preferred roaming list is a concatenated preferred roaming list.

47. The apparatus of claim 43, wherein the preferred roaming list is an extended preferred roaming list.

48. The apparatus of claim 43, wherein the generated data does not include a header.

49. A communication apparatus configured to update a preferred roaming list in a mobile device, the apparatus comprising:
means for receiving a data structure comprising:
an indicator of a data location to modify the preferred roaming list;
an indicator of a type of operation to perform; and
an updated portion of the preferred roaming list; and
means for modifying the preferred roaming list based on the data structure.

50. The apparatus of claim 49, wherein the type of operation is at least one of the following: deletion, insertion, replacement, and partial replacement.

51. The apparatus of claim 49, wherein the received data is received in a plurality of short message service messages.

52. The apparatus of claim 49, wherein the preferred roaming list is a concatenated preferred roaming list.

53. The apparatus of claim 49, wherein the preferred roaming list is an extended preferred roaming list.

54. A communication apparatus configured to update a preferred roaming list in a mobile device, the apparatus comprising:
means for generating a message comprising one or more indicators of one or more operators executable by a removable user identity module (RUIM) card, wherein the one or more operators are configured to modify a preferred roaming list; and
means for transmitting the message to a mobile device.

55. The apparatus of claim 54, wherein the type of operation is at least one of the following: move, store, bit shift, commit, and copy.

56. The apparatus of claim 54, wherein the message comprises a plurality of short message service messages.

57. The apparatus of claim 54, wherein the preferred roaming list is a concatenated preferred roaming list.

58. The apparatus of claim 54, wherein the preferred roaming list is an extended preferred roaming list.

59. A communication apparatus configured to update a preferred roaming list in a mobile device, the apparatus comprising:
means for receiving a message comprising one or more indicators of one or more operators executable by a removable user identity module (RUIM) card, wherein the one or more operators are configured to modify a preferred roaming list; and
means for modifying the preferred roaming list based on the one or more operators.

60. The apparatus of claim 59, wherein the type of operation is at least one of the following: move, store, bit shift, commit, and copy.

61. The apparatus of claim 59, wherein the message comprises a plurality of short message service messages.

62. The apparatus of claim 59, wherein the preferred roaming list is a concatenated preferred roaming list.

63. The apparatus of claim 59, wherein the preferred roaming list is an extended preferred roaming list.

64. A non-transitory computer program product, comprising:
a computer-readable medium comprising:
code for causing a computer to identify a data location in the preferred roaming list;
code for causing a computer to identify a type of operation to perform with respect to the identified data location;
code for causing a computer to generate data indicative of an updated portion of the preferred roaming list; and
code for causing a computer to transmit a message indicative of the data location, the type of operation, and the data to a mobile device.

65. The computer program product of claim 64, wherein the type of operation is at least one of the following: deletion, insertion, replacement, and partial replacement.

66. The computer program product of claim 64, wherein the message comprises a plurality of short message service messages.

67. The computer program product of claim 64, wherein the preferred roaming list is a concatenated preferred roaming list.

68. The computer program product of claim 64, wherein the preferred roaming list is an extended preferred roaming list.

69. The computer program product of claim 64, wherein the generated data does not include a header.

70. A non-transitory computer program product, comprising:
a computer-readable medium comprising:
code for causing a computer to receive a data structure comprising:
an indicator of a data location to modify the preferred roaming list;
an indicator of a type of operation to perform; and
an updated portion of the preferred roaming list; and
code for causing a computer to modify the preferred roaming list based on the data structure.

71. The computer program product of claim 70, wherein the type of operation is at least one of the following: deletion, insertion, replacement, and partial replacement.

72. The computer program product of claim 70, wherein the received data is received in a plurality of short message service messages.

73. The computer program product of claim 70, wherein the preferred roaming list is a concatenated preferred roaming list.

74. The computer program product of claim 70, wherein the preferred roaming list is an extended preferred roaming list.

75. A non-transitory computer program product, comprising:
a computer-readable medium comprising:
code for causing a computer to generate a message comprising one or more indicators of one or more operators executable by a removable user identity module (RUIM) card, wherein the one or more operators are configured to modify a preferred roaming list; and
code for causing a computer to transmit the message to a mobile device.

76. The computer program product of claim 75, wherein the type of operation is at least one of the following: move, store, bit shift, commit, and copy.

77. The computer program product of claim 75, wherein the message comprises a plurality of short message service messages.

78. The computer program product of claim 75, wherein the preferred roaming list is a concatenated preferred roaming list.

79. The computer program product of claim 75, wherein the preferred roaming list is an extended preferred roaming list.

80. A non-transitory computer program product, comprising:
a computer-readable medium comprising:
code for causing a computer to receive a message comprising one or more indicators of one or more operators executable by a removable user identity module (RUIM) card, wherein the one or more operators are configured to modify a preferred roaming list; and
code for causing a computer to modify the preferred roaming list based on the one or more operators.

81. The computer program product of claim 80, wherein the type of operation is at least one of the following: move, store, bit shift, commit, and copy.

82. The computer program product of claim 80, wherein the message comprises a plurality of short message service messages.

83. The computer program product of claim 80, wherein the preferred roaming list is a concatenated preferred roaming list.

84. The computer program product of claim 80, wherein the preferred roaming list is an extended preferred roaming list.
